(19) United States
(12) Patent Application Publication
(10) Pub. No.: US 2025/0245479 A1
(43) Pub. Date: Jul. 31, 2025

(54) SYSTEMS AND METHODS FOR SIAMESE WIDE AND DEEP NEURAL NETWORK RANKING

(71) Applicant: Walmart Apollo, LLC, Bentonville, AR (US)

(72) Inventors: Ramin Giahi, Rego Park, NY (US); Jianpeng Xu, Cupertino, CA (US); Reza Yousefi Maragheh, Los Altos, CA (US); Evren Korpeoglu, San Jose, CA (US); Kannan Achan, Saratoga, CA (US)

(21) Appl. No.: 18/429,128

(22) Filed: Jan. 31, 2024

(51) Int. Cl. G06N 3/045

(52) U.S. Cl. CPC G06N 3/045

(57) ABSTRACT

In various embodiments, systems and methods for generating interfaces including similar elements are disclosed. An interface request identifying an anchor element is received and a set of similar elements for the anchor element identifier is generated by implementing an inference recommendation model generated by a Siamese wide and deep training framework. The inference recommendation model is configured to receive at least one recall set of candidate elements and generate a similarity score for each candidate element in the set of candidate elements and the anchor element. An interface including at least one similar element selected from the set of similar elements is generated and transmitted to a user device associated with the interface request.

### TECHNICAL FIELD

This application relates generally to Siamese wide and deep neural networks, and more particularly, to similar element recommendation using Siamese wide and deep neural networks.

### BACKGROUND

Some current interface systems are configured to present interface elements to users that are representative of similar elements in a corresponding network catalog. The similar interface elements may be identified by similar element recommendation process. Although current similar element recommendation processes are able to identify some examples of similar elements, these systems rely exclusively on positive interactions within the interface. Additionally, current element recommendation processes may generate recommended elements with low accuracy and relevancy.

### SUMMARY

In various embodiments, a system including a non-transitory memory and a processor communicatively coupled to the non-transitory memory is disclosed. The processor is configured to read a set of instructions to receive an interface request identifying an anchor element and generate a set of similar elements for the anchor element identifier by implementing an inference recommendation model generated by a Siamese wide and deep training framework. The inference recommendation model is configured to receive at least one recall set of candidate elements and generate a similarity score for each candidate element in the set of candidate elements and the anchor element. An interface including at least one similar element selected from the set of similar elements is generated and transmitted to a user device associated with the interface request.

In various embodiments, a computer-implemented method is disclosed. The computer-implemented method includes a step of training an inference recommendation model by a Siamese wide and deep training framework comprising a first neural network and a second neural network having identical parameters and weights. The Siamese wide and deep training framework implements a joint loss function based on an output of the first neural network and the second neural network. The computer-implemented method further includes steps of receiving an interface request identifying an anchor element, generating a set of similar elements for the anchor element identifier by implementing the inference recommendation model to receive at least one recall set of candidate elements and generate a similarity score for each candidate element in the set of candidate elements and the anchor element, and generating and transmitting an interface including at least one similar element selected from the set of similar elements to a user device associated with the interface request.

In various embodiments, a non-transitory computer readable medium having instructions stored thereon is disclosed. The instructions, when executed by at least one processor, cause at least one device to perform operations including receiving an interface request identifying an anchor element and generating a set of similar elements for the anchor element identifier by implementing a pair-wise wide and deep network generated by a Siamese wide and deep training framework. The pair-wise wide and deep network is configured to receive at least one recall set of candidate elements and generate a similarity score for each candidate element in the set of candidate elements and the anchor element. The instructions further cause the at least one device to perform operations including generating and transmitting an interface including at least one similar element selected from the set of similar elements to a user device associated with the interface request.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a network environment configured to provide similar element recommendations utilizing a wide and deep pair-wise ranking model, in accordance with some embodiments;

FIG. 2 illustrates a computer system configured to implement one or more processes, in accordance with some embodiments;

FIG. 3 is a flowchart illustrating a similar element ranking and interface generation method, in accordance with some embodiments;

FIG. 4 is a process flow illustrating various steps of the similar element ranking and interface generation method, in accordance with some embodiments;

FIG. 5 illustrates a pair-wise wide and deep ranking model, in accordance with some embodiments;

FIG. 6 illustrates Siamese wide and deep training process, in accordance with some embodiments;

FIG. 7 is a process flow illustrating various steps of the Siamese wide and deep training process, in accordance with some embodiments;

FIG. 8 illustrates an artificial neural network, in accordance with some embodiments; and

FIG. 9 illustrates a deep neural network (DNN), in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Furthermore, in the following, various embodiments are described with respect to methods and systems for generating similar element rankings and generating interfaces including one or more similar elements selected based on the similar element rankings. In various embodiments, an anchor element identifier is provided to a pair-wise ranking model configured to generate a set of ranked similar elements based on the anchor element identifier. The pair-wise ranking model includes a wide and deep structure configured to incorporate wide features and deep features into an inference for generation of the set of ranked similar elements. The pair-wise ranking model is generated via Siamese wide and deep training. In some embodiments, the set of ranked similar elements are provided for inclusion in an interface.

In some embodiments, systems, and methods for generating similar element rankings includes one or more trained pair-wise ranking models. The trained pair-wise ranking models may include one or more models, such as pair-wise wide and deep models configured to incorporate wide features and deep features into an inference for generation of the set of ranked similar elements. The pair-wise ranking models may include at least one sub-network, such as a deep neural network, configured to generate one or more outputs used by a pair-wise function. The pair-wise function may additionally be configured to receive wide features.

In general, a trained function mimics cognitive functions that humans associate with other human minds. In particular, by training based on training data the trained function is able to adapt to new circumstances and to detect and extrapolate patterns.

In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

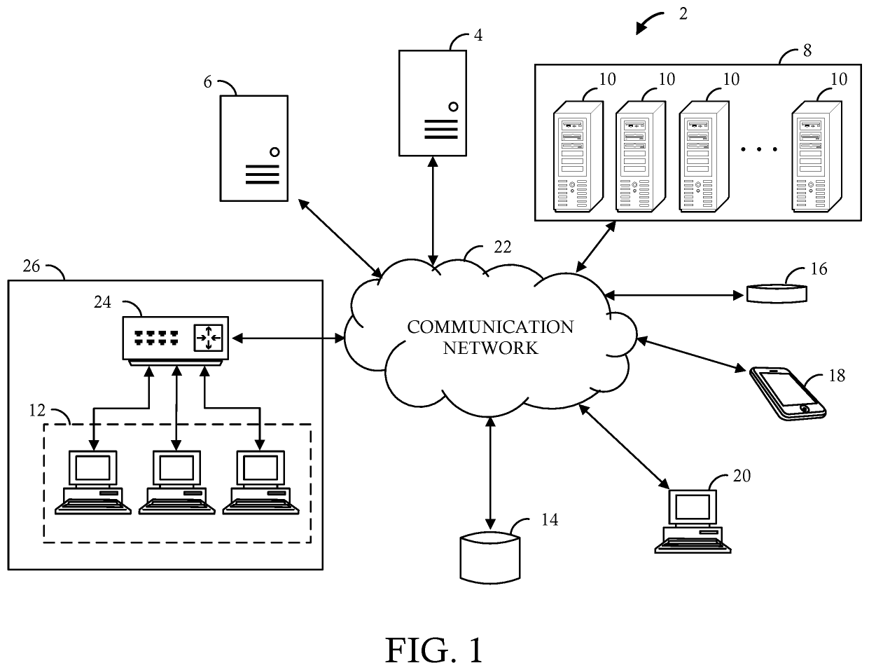

FIG. 1 illustrates a network environment 2 configured to provide similar element recommendations utilizing a wide and deep pair-wise ranking model, in accordance with some embodiments. The network environment 2 includes a plurality of devices or systems configured to communicate over one or more network channels, illustrated as a network cloud 22. For example, in various embodiments, the network environment 2 may include, but is not limited to, an element recommendation computing device 4, a web server 6, a cloud-based engine 8 including one or more processing devices 10, a database 14, and/or one or more user computing devices 16, 18, 20 operatively coupled over the network 22. The element recommendation computing device 4, the web server 6, the processing device(s) 10, and/or the user computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the element recommendation computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the element recommendation computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an e-commerce network environment. In some embodiments, the element recommendation computing device 4, the processing devices 10, and/or the web server 6 are operated by the network environment provider, and the user computing devices 16, 18, 20 are operated by users of the network environment. In some embodiments, the processing devices 10 are operated by a third party (e.g., a cloud-computing provider).

The workstation(s) 12 are operably coupled to the communication network 22 via a router (or switch) 24. The workstation(s) 12 and/or the router 24 may be located at a physical location 26 remote from the element recommendation computing device 4, for example. The workstation(s) 12 may communicate with the element recommendation computing device 4 over the communication network 22. The workstation(s) 12 may send data to, and receive data from, the element recommendation computing device 4. For example, the workstation(s) 12 may transmit data related to tracked operations performed at the physical location 26 to element recommendation computing device 4.

Although FIG. 1 illustrates three user computing devices 16, 18, 20, the network environment 2 may include any number of user computing devices 16, 18, 20. Similarly, the network environment 2 may include any number of the element recommendation computing device 4, the web server 6, the processing devices 10, the workstation(s) 12, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the element recommendation computing device 4, the web server 6, the workstation(s) 12, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the user computing devices 16, 18, 20 may communicate with the web server 6 over the communication network 22. For example, each of the user computing devices 16, 18, 20 may be operable to view, access, and interact with a website, such as an e-commerce website, hosted by the web server 6. The web server 6 may transmit user session data related to a user's activity (e.g., interactions) on the website. For example, a user may operate one of the user computing devices 16, 18, 20 to initiate a web browser that is directed to the website hosted by the web server 6. The user may, via the web browser, perform various operations such as searching one or more databases or catalogs associated with the displayed website, view item data for elements associated with and displayed on the website, and click on interface elements presented via the website, for example, in the search results. The website may capture these activities as user session data, and transmit the user session data to the element recommendation computing device 4 over the communication network 22. The website may also allow the user to interact with one or more of interface elements to perform specific operations, such as selecting one or more items for further processing.

In some embodiments, the element recommendation computing device 4 may execute one or more models, processes, or algorithms, such as a pair-wise wide and deep model etc., to identify similar elements within a network catalog. The element recommendation computing device 4 may transmit a set of similar elements to the web server 6 over the communication network 22, and the web server 6 may display interface elements associated with the similar elements on the website to the user. For example, the web server 6 may display interface elements associated with similar elements to the user on a homepage, a catalog webpage, an item webpage, a window or interface of a chatbot, a search results webpage, or a post-transaction webpage of the website (e.g., as the user browses those respective webpages).

In some embodiments, the web server 6 transmits a similar element generation request to the element recommendation computing device 4. The similar element generation request may include an anchor item identifier. The similar element generation request may be received by the element recommendation computing device 4. The element recommendation computing device 4 may execute a pair-wise wide and deep model to generate a set of similar elements in response to the similar element generation request. The set of similar elements may be provided as a response to the similar element generation request.

The element recommendation computing device 4 is further operable to communicate with the database 14 over the communication network 22. For example, the element recommendation computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the element recommendation computing device 4, in some embodiments, the database 14 may be a local storage device, such as a hard drive, a non-volatile memory, or a USB stick. The element recommendation computing device 4 may store interaction data and/or session data received from the web server 6, model parameters and/or weights, sets of similar elements generated by one or more pair-wise wide and deep models, and/or any other suitable data in the database 14.

In some embodiments, the element recommendation computing device 4 generates training data for one or more pair-wise wide and deep models for use in a Siamese wide and deep training process. The element recommendation computing device 4 and/or one or more of the processing devices 10 may train one or more models based on corresponding training data. The element recommendation computing device 4 may store the models in a database, such as in the database 14 (e.g., a cloud storage database).

The models, when executed by the element recommendation computing device 4, allow the element recommendation computing device 4 to generate sets of similar elements based on wide and deep features of elements in a network catalog. For example, the element recommendation computing device 4 may obtain one or more models from the database 14. The element recommendation computing device 4 may then receive, in real-time from the web server 6, a similar element generation request including an anchor item identifier. In response to receiving the similar element generation request, the element recommendation computing device 4 may execute one or more models to generate one or more sets of similar elements.

In some embodiments, the element recommendation computing device 4 assigns the models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units. Based on the output of the models, element recommendation computing device 4 may generate sets of similar elements for inclusion in one or more interfaces.

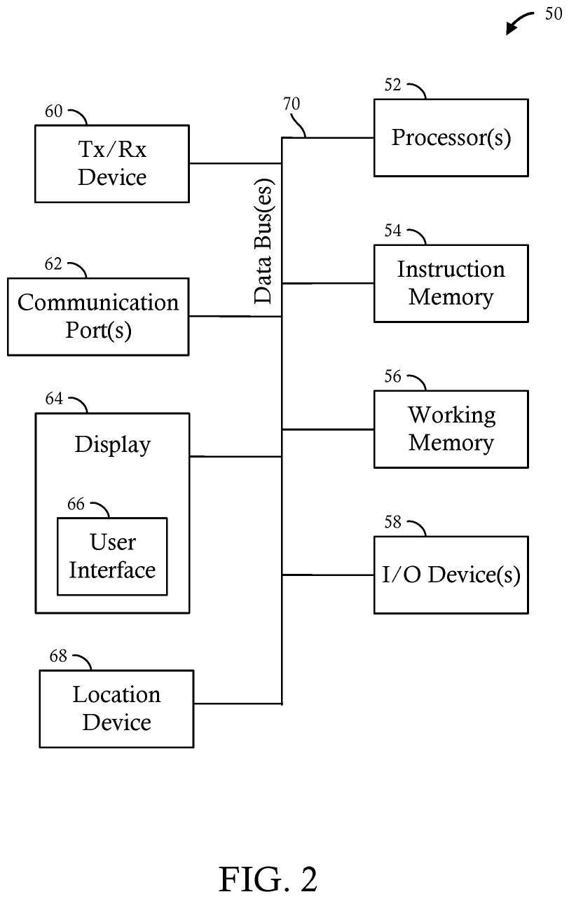

FIG. 2 illustrates a block diagram of a computing device 50, in accordance with some embodiments. In some embodiments, each of the element recommendation computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for generating pair-wise wide and deep models and/or generating sets of similar elements using pair-wise wide and deep models, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C #, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with one or more similar elements selected by a pair-wise wide and deep model. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

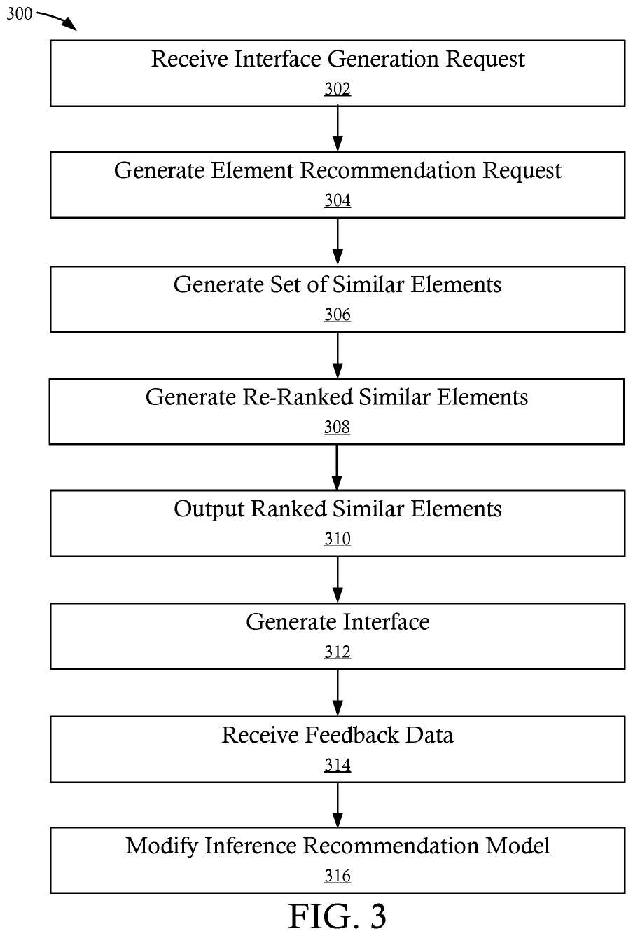

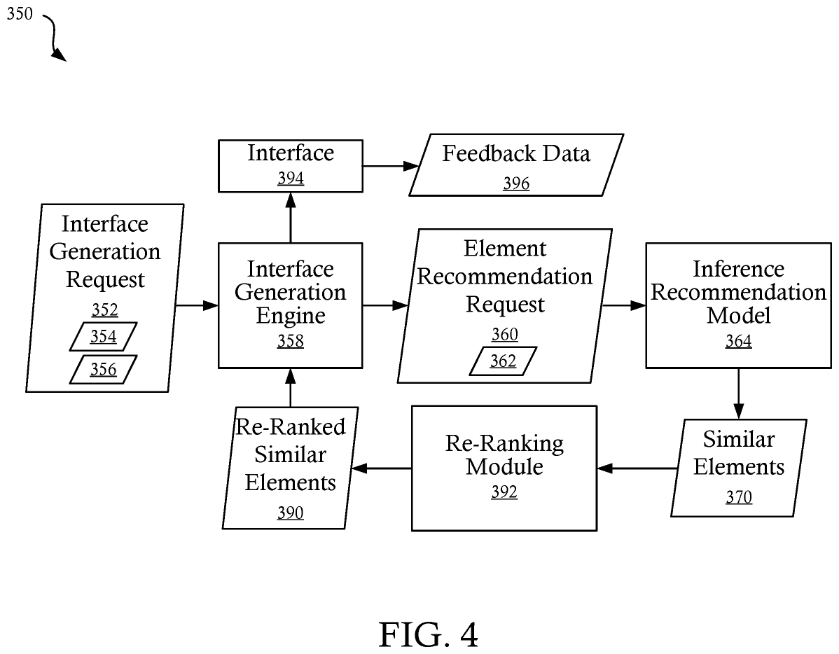

FIG. 3 is a flowchart illustrating a similar element ranking and interface generation method 300, in accordance with some embodiments. FIG. 4 is a process flow 350 illustrating various steps of the similar element ranking and interface generation method 300, in accordance with some embodiments. The similar element ranking and interface generation method 300 may be executed by any suitable system, device, module, engine, etc., and/or any combination thereof, such as, for example, the element recommendation computing device 4 discussed above. In some embodiments, various portions of the similar element ranking and interface generation method 300 may be implemented and/or executed by multiple systems, devices, etc., such as, for example, the element recommendation computing device 4, the web server 6, and/or the processing device(s) 10.

At step 302, an interface generation request 352 is received. The interface generation request 352 includes a request for a user interface that includes one or more interface elements representative of one or more network elements (“items”) included in a catalog associated with the network environment. The interface elements may include one or more interface elements generated by one or more recommendation processes, such as a similar item recommendation process. Similar item recommendation processes may be configured to select interface elements representative of items that are similar (e.g., same type, substitutable, etc.) to one or more other items included in the generated interface, other portions the generated interface, the user device and/or user associated with the interface generation request 352, etc.

The interface generation request 352 may include a user identifier 354 associated with a user data structure. The user data structure includes one or more data elements including, but not limited to, one or more data elements representative of user features (e.g., self-reported information, user preferences, membership status, etc.), historical interaction data (e.g., data representative of prior interactions with interface elements included in an interface presented via a user device associated with the user identifier), and/or any other suitable user data. The interface generation request 352 may be received by any suitable process, module, engine, etc., such as an interface generation engine 358.

In some embodiments, the interface generation request 352 may include session data 356 including data representative of a current session in which the interface generation request 352 is generated. The session data 356 may include one or more data elements and/or features representative of one or more interactions occurring during a current session, one or more personas or contexts assigned to a current session, one or more session preferences, etc. In some embodiments, session data 356 may identify one or more product types, as discussed in greater detail below.

At step 304, an element recommendation request 360 is generated. The element recommendation request 360 may include a request for one or more recommended (e.g., complementary, similar, etc.) elements to be included within a generated interface. The element recommendation request 360 may include an anchor element identifier 362 and/or features corresponding to the anchor element. The anchor element identifier 362 may be generated based on one or more user interactions identified in the session data 356. For example, in some embodiments, the anchor element identifier 362 corresponds to a most-recent interaction included in the session data 356 identifying an interface element that generated and/or was interacted with in conjunction with the interface generation request 352. In other embodiments, one or more anchor item identifiers 362 may be generated based on historical user interaction data, predetermined by the network environment, and/or otherwise provided for inclusion in the element recommendation request 360.

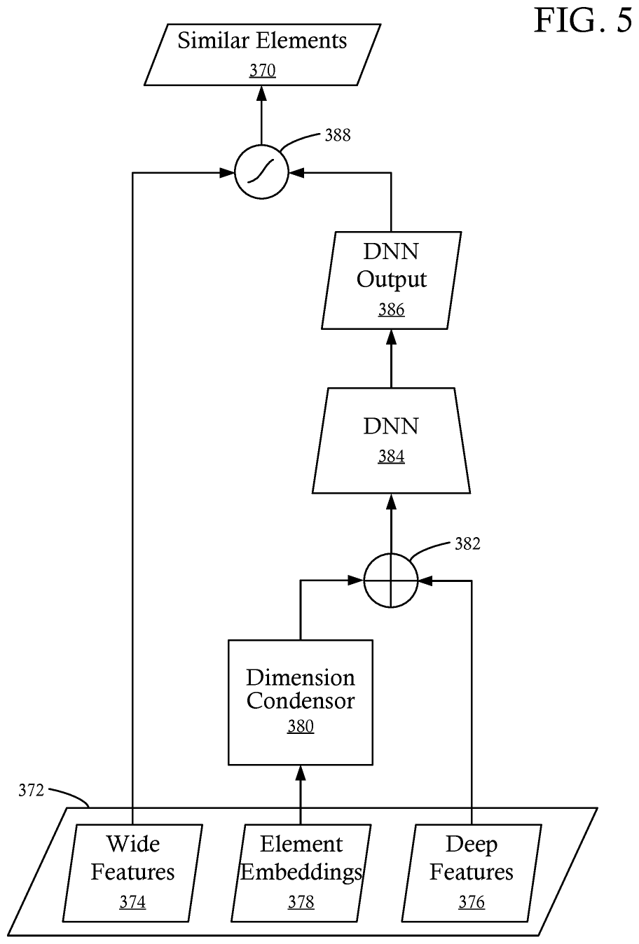

At step 306, a set of similar elements 370 is generated in response to the element recommendation request 360. The set of similar elements 370 include one or more elements similar to an anchor element associated with the anchor item identifier 362. In some embodiments, the set of similar elements 370 is generated by an inference recommendation model 364. The inference recommendation model 364 may include one or more trained layers and/or sub-models configured to generate the set of similar elements 370. For example, the inference recommendation model 364 may include a pair-wise wide and deep ranking model 364a, as illustrated in FIG. 5. Although embodiments are illustrated including a single inference recommendation model 364, it will be appreciated that multiple instances of the inference recommendation model 364 may be executed simultaneously and/or sequentially to generate sets of similar elements 370 for each of a received anchor item identifier 362.

The inference recommendation model 364 may be configured to receive features corresponding to an anchor element represented by the anchor element identifier 362 and features representative of elements in one or more element recall sets 366 (e.g., sets of candidate elements selected based on one or more criteria, such as category, features, title, etc.). The inference recommendation model 364 is configured to generate the set of similar elements 370 by pair-wise ranking the elements in the one or more element recall sets 366 according to relative similarity to the anchor element associated with the anchor element identifier 362.

In some embodiments, the inference recommendation model 364 is configured to generate and/or receive doublets 372 including the anchor element (e.g., a feature dataset for the anchor element) and each of the candidate elements (e.g., a feature dataset for each corresponding candidate element) in the received recall sets 366. Each doublet may include wide feature set 374, a deep feature set 376, and/or element embeddings 378 associated with each of the anchor element and the corresponding candidate element in the doublet. As used herein, wide features refer to inputs used by neural networks including a large number of neurons at each trained layer and deep features refer to inputs used by neural networks having a higher number of hidden layers with fewer neurons at each layer. Examples of wide networks may include linear networks configured to consider a large number of features at each trained layer, providing feature transformations that are effective and interpretable. Examples of deep networks including deep learning networks that can generalize unseen feature combinations and can operate on sparse feature sets.

In some embodiments, one or more of the input elements, such as the element embeddings associated with the anchor element and/or the candidate elements, may be condensed prior to receipt by the inference recommendation model 364. For example, in some embodiments, the element embeddings 378 are provided to a dimension condenser 380 (e.g., embedding condenser) configured to generate reduced dimension embeddings for use by the inference recommendation network 364. The element embeddings 378 may include one or more embeddings, such as one or more text embeddings, one or more image embeddings, etc., representative of sub-elements associated with an underlying element. For example, the element embeddings 378 may include, but are not limited to, embeddings representative of a title, description, textual features, image, etc. associated with an element in an element catalog of the network environment. In some embodiments, one or more features and/or feature sets may be preprocessed to impute or estimate missing values. It will be appreciated that any suitable preprocessing may be applied to the input dataset.

FIG. 5 illustrates a pair-wise wide and deep ranking model 364a configured to generate a set of similar elements 370 by applying pair-wise ranking to doublets 372 based on the wide feature set 374, the deep feature set 376, and the corresponding embeddings 378 of each doublet 372, in accordance with some embodiments. In some embodiments, the parameters and/or weights of the pair-wise wide and deep network 364a are generated by a Siamese wide and deep training process, as discussed in greater detail below. In some embodiments, the corresponding element embeddings 378 include condensed embeddings generated by a dimension condenser 380.

The pair-wise wide and deep ranking model 364a is configured to concatenate the element embeddings 378 (e.g., the condensed element embeddings) and the deep feature set 376, for example via a concatenation sub-process 382, and provide the concatenated features to a deep neural network 384. The deep neural network 384 generates an output 386 which is provided, in conjunction with the wide feature set 374, to a pair-wise ranking submodule 388 for generating a pair-wise ranking value of the corresponding doublet 372. In some embodiments, the pair-wise ranking submodule 388 ranks the candidate element of each doublet 372 based on the corresponding pair-wise ranking value for the doublet 372 and outputs the ranked set of candidate elements as the set of similar elements 370.

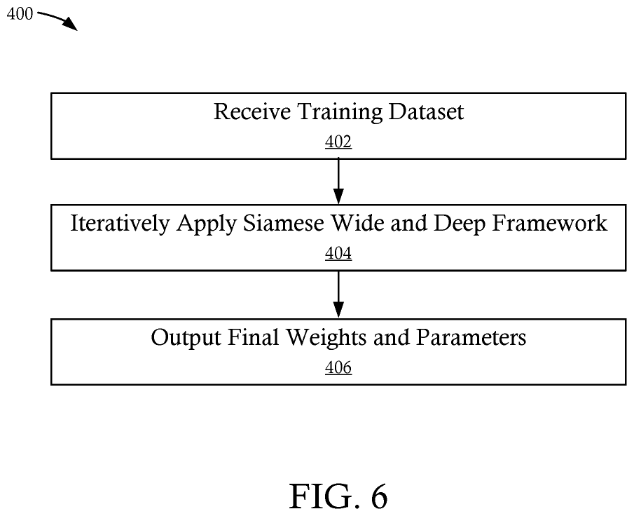

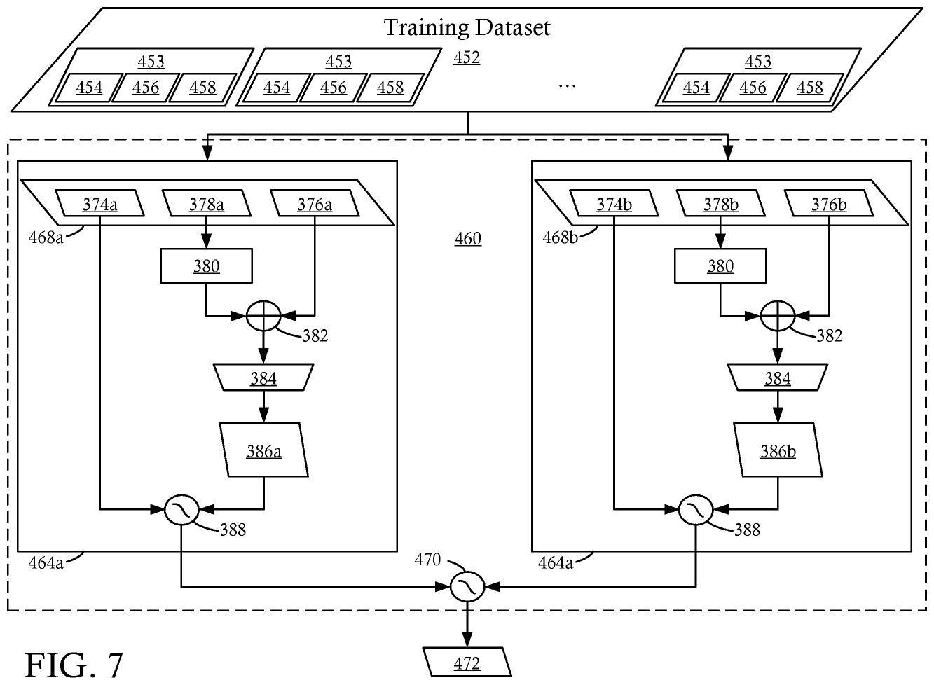

FIG. 6 illustrates Siamese wide and deep training process 400, in accordance with some embodiments. FIG. 7 is a process flow 450 illustrating various steps of the Siamese wide and deep training process 400, in accordance with some embodiments. At step 402, a training dataset 452 is received by a Siamese wide and deep framework 460. The training dataset 452 may include any suitable data for use in training and/or configuration of the Siamese Wide and Deep Network, such as, for example, triplets data elements 453 including data features for each of an anchor element, a first candidate element, and a second candidate element, e.g., <anchor element, first candidate element, second candidate element>. Each of the triplet data elements 453 may include one or more feature sets for each of the corresponding elements, such as, for example, a wide feature set 454, a deep feature set 456, and an element embedding 458 for each element in the corresponding triplet 453.

The triplet data elements 453 and/or underlying features may be defined by combining an anchor element, a interacted-with candidate element, and a not-interacted with candidate element. For example, in the context of an e-commerce environment, an anchor element may include a catalog item that was searched for and/or initially selected by a user (e.g., a view interaction), the first candidate element may include a first catalog item that was displayed and interacted with (e.g., an add-to-cart or purchase interaction) on an interface page with the anchor element, and the second candidate element may include a second catalog item that was displayed but not interacted with (e.g., not added to cart or purchased) on the interface page with the anchor element. In such embodiments, the first candidate element may be considered a “positive” interaction or element and the second candidate element may be considered a “negative” interaction or element. Although specific embodiments are discussed herein, it will be appreciated that triplet data elements may be generated according to any predetermined criteria.

In some embodiments, one or more of the features and/or feature sets in the training dataset 452 may be pre-processed and/or otherwise prepared for use by the Siamese wide and deep framework 460. For example, in some embodiments, the element embeddings 458 are provided to a dimension condenser 380 (e.g., embedding condenser) configured to generate reduced dimension embeddings for use by the Siamese wide and deep framework 460. Although embodiments are illustrated including a dimension condenser 380 within each of corresponding neural networks 464a, 464b, it will be appreciated that a single dimension condenser 380 may be implemented and utilized to condense element embeddings prior to providing the element embeddings to the Siamese wide and deep framework 460. As another example, in some embodiments, one or more features and/or feature sets may be preprocessed to impute or estimate missing values. It will be appreciated that any suitable preprocessing may be applied to the training dataset 452. In some embodiments, the element embeddings 458 include one or more embeddings, such as one or more text embeddings, one or more image embeddings, etc., representative of sub-elements associated with an underlying element. For example, the element embeddings 458 may include, but are not limited to, embeddings representative of a title, description, textual features, image, etc. associated with an element in an element catalog of the network environment.

In some embodiments, at least a portion of the training dataset 452 includes features generated based on interaction data and/or session data for one or more anchor elements and candidate elements. For example, interaction data for each anchor element and corresponding candidate elements may be generated based on interactions with interface elements for the candidate elements within an interface including the corresponding anchor item, including both positive (e.g., active) and negative (e.g., passive) interactions. Interaction data may also be generated based on determining aggregated co-counts such as, for example, co-views, co-purchases, or view-buy counts, for each anchor element and candidate element. Co-views may identify a number of times where an anchor element and a candidate element are viewed together during a session. Co-purchases may identify a number of times where an anchor element and a candidate element are bought during a same user session. Aggregated view-buy counts may be, for example, a total number of times each anchor element and recommended element has been viewed and/or purchased. In some embodiments, the interaction data may be generated based on user session data over a previous amount of time.

In some embodiments, the training dataset 452 may include categorical feature data for each element. Categorical data may identify for each element, for example, a taxonomical categorization. For example, a taxonomical categorization for brand “A” laptops may be, for example, “Electronics/Computers/Laptops/Brand A Laptops”. Additionally or alternatively, categorical data may identify network-specific features. For example, in the context of an e-commerce environment, categorical data may identify a product type, a brand, a division, a department (e.g., a retailer department, such as meat, dairy, or produce departments) a category, a subcategory, etc. Categorical data may also identify other categorical data related to each element.

At step 404, the Siamese wide and deep framework 460 receives the training dataset 452 and applies an iterative Siamese training process to generate a set of two neural networks 464a, 464b (e.g., “twin networks 464”). The twin networks 464 include identical subnetworks utilizing the same configurations with the same weights and parameters. The first neural network 464a is configured to receive a doublet input 466a including a wide feature input 374a, a deep feature input 376a, and element embeddings 378a for each of the anchor element and the first candidate element and the second neural network 464b is configured to receive a doublet input 468b including a wide feature input 374b, a deep feature input 376b, and element embeddings 376c for each of the anchor element and the second candidate element. The doublet inputs 468a, 468b may be generated from a corresponding triplet 453 of the training dataset 452. In some embodiments, the twin networks 464 each include a pair-wise wide and deep network.

By jointly utilizing and training models on wide and deep features, the Siamese wide and deep framework 460 combines the benefits of wide and deep process, e.g., memorization and generalization, to provide additional accuracy and recall with respect to similar element recommendations. The wide feature inputs 374a, 374b may include the wide feature set associated with the corresponding received doublet input 468a, 468b e.g., the wide feature set associated with the anchor element and the first candidate element or associated with the anchor element and the second candidate element.

In some embodiments, the deep feature inputs 376a, 376b may be concatenated with the corresponding element embeddings 378a, 378b (e.g., condensed element embeddings) by a concatenation process 382 and provided to a deep neural network 384. The deep neural network 384 is configured to generate an output 386a, 386b that is provided, in conjunction with the corresponding wide feature inputs 374a, 374b to a pair-wise ranking submodule 388a, 388b for generating a pair-wise ranking value of the corresponding doublet input 468a, 468b.

In some embodiments, the outputs of each of the twin networks 464 are provided to a joint loss function 470. The joint loss function 470 allows modification of the shared weights and parameters of the twin networks 464 based on the output of both neural networks 464a, 464b. For example, in some embodiments, the joint loss function 470 of the Siamese wide and deep framework 460 may include an objective function. The joint loss function 470 may be expressed as:

Loss=max(0,f(anc,cand₁)−f(anc,cand₂)+margin)

where anc is the anchor element, cand₁ is the first candidate element, cand₂ is the second candidate element, and margin is a value added to adjust the weight of the second candidate element (e.g., the unselected candidate element). The weights of each of the neural networks 464a, 464b are iteratively adjusted simultaneously until the joint loss function is satisfied. By utilizing a joint loss function 470, the Siamese wide and deep framework 460 is configured to incorporate both positive interactions (e.g., active interactions) and negative interactions (e.g., passive interactions, non-interactions) into generated recommendations.

The received training dataset 452 may be processed and/or normalized prior to training of the Siamese wide and deep framework 460. For example, in some embodiments, the training dataset 452 can be augmented by imputing or estimating missing values of one or more features associated with the twin networks 464. In some embodiments, processing of the received training dataset 452 includes outlier detection configured to remove data likely to skew training of a model, such as a pair-wise ranking model, a deep neural network, etc. In some embodiments, processing of the received training dataset 452 includes removing features that have limited value with respect to training of the twin networks 464.

An iterative training process iteratively adjusts an untrained (e.g., base) Siamese wide and deep framework 460 and/or a partially or previously trained Siamese wide and deep framework 460 (e.g., generated from the weights and/or parameters corresponding to a previously trained inference recommendation model 364). The iterative training process is configured to iteratively adjust the shared parameters (e.g., hyperparameters) and weights of the Siamese wide and deep framework 460 based on the shared loss function 470.

After each iteration of the training process, a determination is made whether the training process is complete. The determination can be based on any suitable parameters. For example, in some embodiments, a training process can complete after a predetermined number of iterations. As another example, in some embodiments, a training process can complete when it is determined that the loss function satisfies one or more predetermined criteria.

At step 406, the shared weights and parameters of the twin networks 464 are output as a set of final weights and parameters 472. The set of final weights and parameters 472 may be used to instantiate and/or execute one or more inference recommendation models 364. e.g., one or more pair-wise wide and deep similarity inference recommendation models. An implemented inference recommendation model 364 may include a structure identical to one of the twin networks 464, such as the first neural network 464a. The set of final weights and parameters 472 may be stored in a data store, such as database 14, and/or provided directly for implementation of one or more models, such as implementation of an inference recommendation model 364.

In some embodiments, the Siamese wide and deep framework 460 provides for consideration of platform-specific features with sparse catalog features. The Siamese wide and deep framework 460 provides a learning to rank architecture that minimizes a triplet loss function for an anchor element, a first candidate element, and a second candidate element (and corresponding features thereof). Training of the Siamese wide and deep framework 460 as disclosed herein generates an optimal ranking function (e.g., optimal inference recommendation model 364) from the training dataset 452 by maximizing a difference of the doublets <anchor element, first candidate element> and <anchor, second candidate element> with extra margin. The use of the Siamese wide and deep framework 460 and generated doublets for each triplet input set reduces overall training time and resource requirements, for example, reducing training data dimensions. Inference recommendation models 364 generated using the Siamese wide and deep framework 460 provide a significant improvement in similar element ranking computational time upon implementation and allow for direct application of a ranking function to the set of <anchor element, candidate elements> in the recall sets 366. In some embodiments, the generated inference recommendation model 364 reduces complexity of the ranking function from 0(n²) to O(n.log(n)) and enables ranking of a recall set 366 of size n in n operations.

In some embodiments, the disclosed Siamese wide and deep framework 460 and generation of corresponding inference recommendation models 364 provides for parallelization for model training and execution (e.g., inferencing). For example, the disclosed Siamese wide and deep framework 460, and a corresponding inference recommendation model 364 generated therefrom, allows for multiple simultaneous processes to be used to process input features to generate input doublets, for example, by segmenting input features by anchor elements and candidate elements in a corresponding recall set 366. A typical Siamese network implementation does not allow feature interactions between anchor elements and candidate elements due to model complexity and training inefficiency. In contrast, the disclosed Siamese wide and deep framework 460 includes interaction feature preparation that enables efficient training. One or more pre-processing tools, such as a data API tool, may be used to generate batch training dataset 452 that encapsulate all relevant training triplets, e.g., <anchor element, candidate element 1, candidate element 2>, allowing training doublets to be generated without pre-loading of the doublets into memory and allowing very large training datasets 452 to be used.

With reference again to FIGS. 3-4, at optional step 308, a set of re-ranked similar elements 390 is generated. The set of re-ranked similar elements 390 may be generated by re-ranking the set of similar elements 370 according to one or more re-ranking criteria. In some embodiments, a re-ranking module 392 is configured to apply one or more re-ranking processes and/or models. For example, the re-ranking module 392 may be configured to apply element category specific re-ranking processes to re-rank the set of similar elements 370 to generate the set of re-ranked similar elements 390. It will be appreciated that any suitable re-ranking process may be applied by the re-ranking module 392.

In some embodiments, the re-ranking module 392 is configured to incorporate a trade-off (e.g., balancing) between an expected performance of an element (e.g., rate of a first interaction, value of first interactions (e.g., gross value), etc.) and the relevance (e.g., second interaction rate (e.g., click-through rate) vs. first interaction rate (e.g., purchase rate). In some embodiments, the re-ranking module 392 is configured to receive a set similar elements 370 including K elements, where K is a number less than the size of a recall set 366 used to generate the set of similar elements 370. The re-ranking module 392 may be configured to apply a re-ranking process such that:

RankScoreᵢ=sᵢ*(norm(pi)+λ)

where sᵢ is the inference score (i.e., score generated by the inference recommendation model 364 such as pair-wise ranking score) for the i^{th} candidate element, norm(pi) is a normalized feature value (e.g., price) for the i^{th} candidate element, and λ is a hyperparameter representative of a tradeoff between the expected performance of the i^{th} candidate element and the relevance of the i^{th} candidate element. In some embodiments, λ is determined by tuning a multi-objective function of expected performance and a normalized discounted cumulative gain of one or more processes (e.g., offline tests).

In some embodiments, the re-ranked similar elements 390 are generated by ranking the Top-K elements and mapping their corresponding RankScore between 0.5 and 1 and directly mapping an inference score for elements not in the Top-K elements between 0 and 0.5.

At step 310, the set of re-ranked similar elements 390, or in embodiments omitting step 308 the set of similar elements 370, is output and, at step 310, an interface 394 including one or more of the elements in the set of re-ranked similar elements 390 (e.g., one or more elements from the set of similar elements 370) is generated. The set of re-ranked similar elements 390 may be provided to the interface generation engine 358 for inclusion in a generated interface 394. The elements include in the interface 394 may be selected from the set of re-ranked similar elements 390 in ranked order (e.g., highest ranked elements first), randomly selected, selected based on any suitable criteria, etc. As one non-limiting example, in some embodiments, the set of re-ranked similar elements 390 may be presented in one or more element containers, such as one or more carousels, included in the generated interface 394.

The interface 394 may be generated by generating and transmitting instructions for a user device to generate the interface 394 locally. The transmitted instructions may include instructions for obtaining interface elements, including the set of re-ranked similar elements 390, from one or more network-accessible locations and/or may include interface elements, such as the set of re-ranked similar elements 390, embedded within the instructions. Although specific embodiments are discussed herein, it will be appreciated that the interface 394 may be generated using any suitable interface generation process, such as template completion, modification of cached interfaces, etc.

At optional step 314, feedback data 396 is received. Feedback data may include one or more interactions with one or more of the set of re-ranked similar elements 390, e.g., one or more interface elements representative of an element in the set of re-ranked similar elements 390. At optional step 316, the inference recommendation model 364 may be re-trained and/or adjusted based on a training dataset including at least a portion of the feedback data 396. For example, when the feedback data 396 indicates a positive interaction with a similar element displayed in conjunction with an anchor element that is not reflected in the original training dataset 452, an updated training dataset may be generated and the inference recommendation model 364 may be re-trained using the updated training dataset. Similarly, when the feedback data 396 indicates a negative interaction with a similar element that was selected by the inference recommendation model 364, an updated training dataset may be generated and the inference recommendation model 364 may be re-trained using the updated training dataset. Although specific embodiments are discussed herein, it will be appreciated that any suitable portions of the disclosed systems and methods may be modified based on the feedback data 396. The disclosed similar element ranking and interface generation method 300 provides an improvement over interfaces generated using traditional similar element recommendation processes, for example, by providing higher relevance similar elements for inclusion in generated interfaces.

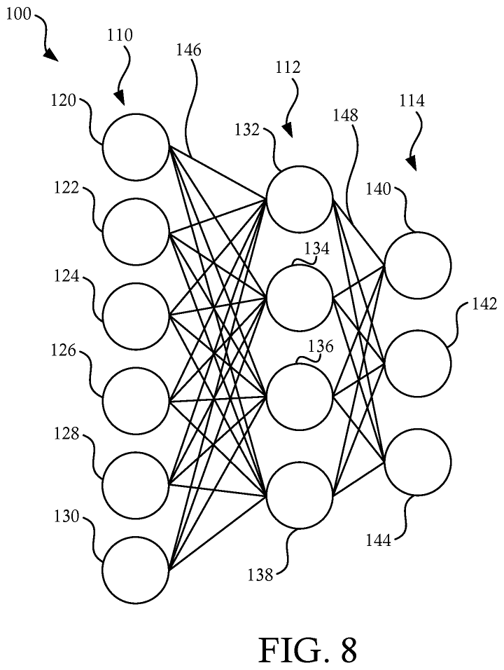

FIG. 8 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 8 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 may be arranged in layers 110-114, wherein the layers may comprise an intrinsic order introduced by the edges 146-148 between the nodes 120-144 such that edges 146-148 exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 may be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number may be assigned as a value to every node 120-144 of the neural network 100. Here, xᵢ⁽ⁿ⁾ denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 may comprise a weight being a real number, in particular, the weight is a real number within the interval [−1, 1], within the interval [0, 1], and/or within any other suitable interval. Here, w_{i,j}^{(m,n)} denotes the weight of the edge between the i-th node 120-138 of the m-th layer 110, 112 and the j-th node 132-144 of the n-th layer 112, 114. Furthermore, the abbreviation w_{i,j}⁽ⁿ⁾ is defined for the weight w_{i,j}^{(n,n+1)}.

In particular, to calculate the output values of the neural network 100, the input values are propagated through the neural network. In particular, the values of the nodes 132-144 of the (n+1)-th layer 112, 114 may be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 may be calculated based on the values of the input layer 110 of the neural network and/or based on the values of a prior hidden layer, etc.

In order to set the values w_{i,j}^{(m,n)} for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers δⱼ⁽ⁿ⁾ may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f is the first derivative of the activation, function, and yⱼ⁽ⁿ⁺¹⁾ is the comparison training value for the j-th node of the output layer 114.

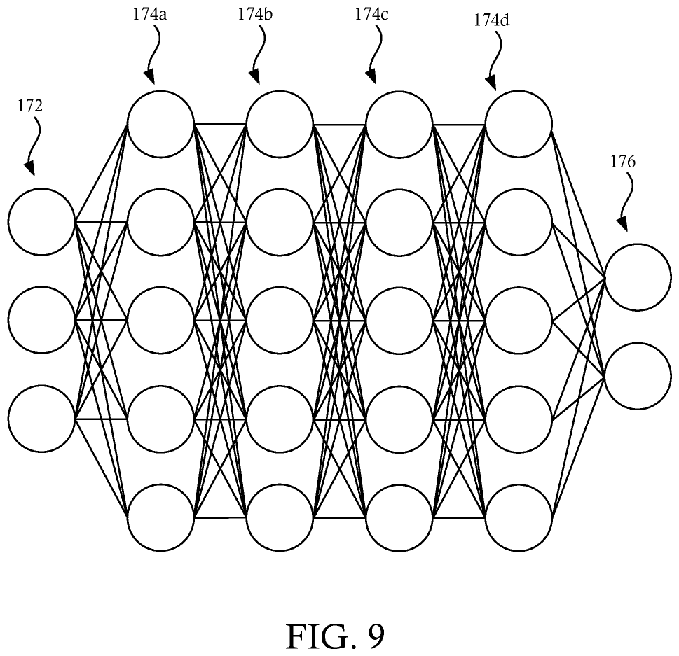

FIG. 9 illustrates a deep neural network (DNN) 170, in accordance with some embodiments. The DNN 170 is an artificial neural network, such as the neural network 100 illustrated in conjunction with FIG. 8, that includes representation learning. The DNN 170 may include an unbounded number of (e.g., two or more) intermediate layers 174a-174d each of a bounded size (e.g., having a predetermined number of nodes), providing for practical application and optimized implementation of a universal classifier. Each of the layers 174a-174d may be heterogenous. The DNN 170 may be configured to model complex, non-linear relationships. Intermediate layers, such as intermediate layer 174c, may provide compositions of features from lower layers, such as layers 174a, 174b, providing for modeling of complex data.

In some embodiments, the DNN 170 may be considered a stacked neural network including multiple layers each configured to execute one or more computations. The computation for a network with L hidden layers may be denoted as:

$$f ( x ) = f [ {a}^{( L + 1 )} ( {h}^{( L )} ( {a}^{( L )} ( … ( {h}^{( 2 )} ( {a}^{( 2 )} ( {h}^{( 1 )} ( {a}^{( 1 )} ( x ) ) ) ) ) ) ) ) ]$$

where a^{(l)}(x) is a preactivation function and h^{(l)}(x) is a hidden-layer activation function providing the output of each hidden layer. The preactivation function a^{(l)}(x) may include a linear operation with matrix W^{(l)} and bias b^{(l)}, where:

$${a}^{( l )} ( x ) = {W}^{( l )} x + {b}^{( l )}$$

In some embodiments, the DNN 170 is a feedforward network in which data flows from an input layer 172 to an output layer 176 without looping back through any layers. In some embodiments, the DNN 170 may include a backpropagation network in which the output of at least one hidden layer is provided, e.g., propagated, to a prior hidden layer. The DNN 170 may include any suitable neural network, such as a self-organizing neural network, a recurrent neural network, a convolutional neural network, a modular neural network, and/or any other suitable neural network.

In some embodiments, a DNN 170 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + … + {f}_{K} ( {x}_{K} )$$

where β is an offset and each fᵢ is parametrized by a neural network. In some embodiments, the DNN 170 may include a neural multiplicative model (NMM), including a multiplicative form for the NAM mode using a log transformation of the dependent variable y and the independent variable x:

$$y = {e}^{β} {e}^{f ( log x )} {e}^{{\sum }_{i} {f}_{i}^{d} ( {d}_{i} )}$$

where d represents one or more features of the independent variable x.

Identification of similar interface elements associated with anchor elements can be burdensome and time consuming for users, especially if computational complexity limits the number of candidate elements that can be considered and processed for inclusion in an interface. Typically, a user may locate information regarding similar elements by navigating a browse structure, sometimes referred to as a “browse tree,” in which interface pages or elements are arranged in a predetermined hierarchy. Such browse trees typically include multiple hierarchical levels, requiring users to navigate through several levels of browse nodes or pages to arrive at an interface page of interest. Thus, the user frequently has to perform numerous navigational steps to arrive at a page containing information regarding similar elements.

Systems including trained inference recommendation models 364, as disclosed herein, significantly reduce this problem, allowing users to locate similar elements with fewer, or in some case no, active steps. For example, in some embodiments described herein, when a user is presented with interface elements representative of similar catalog elements, each interface element includes, or is in the form of, a link to an interface page for performing interactions with the corresponding similar catalog element. Each recommendation thus serves as a programmatically selected navigational shortcut to an interface page, allowing a user to bypass the navigational structure of the browse tree. Beneficially, programmatically identifying similar elements and presenting a user with navigations shortcuts to these tasks may improve the speed of the user's navigation through an electronic interface, rather than requiring the user to page through multiple other pages in order to locate the similar elements via the browse tree or via a search function. This may be particularly beneficial for computing devices with small screens, where fewer interface elements are displayed to a user at a time and thus navigation of larger volumes of data is more difficult.

It will be appreciated that inference recommendation model training and identification of similar elements using a trained inference recommendation model as disclosed herein, particularly on large datasets intended to be used e-commerce environments, is only possible with the aid of computer-assisted machine-learning algorithms and techniques, such as the disclosed Siamese wide and deep framework 554. In some embodiments, machine learning processes including inference recommendation models 364 are used to perform operations that cannot practically be performed by a human, either mentally or with assistance, such as identification of similar elements for inclusion in generated interfaces.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a non-transitory memory;
a processor communicatively coupled to the non-transitory memory, wherein the processor is configured to read a set of instructions to:
receive an interface request identifying an anchor element;
generate a set of similar elements for the anchor element identifier by implementing an inference recommendation model generated by a Siamese wide and deep training framework, wherein the inference recommendation model is configured to receive at least one recall set of candidate elements and generate a similarity score for each candidate element in the set of candidate elements and the anchor element; and
generate and transmit an interface including at least one similar element selected from the set of similar elements to a user device associated with the interface request.

2. The system of claim 1, wherein the inference recommendation model comprises a pair-wise wide and deep network.

3. The system of claim 1, wherein the Siamese wide and deep training framework is configured to receive a training dataset including a plurality of triplets including a training anchor element, a first candidate element, and a second candidate element.

4. The system of claim 3, wherein the Siamese wide and deep training framework is configured to generate a first doublet and a second doublet for each triplet in the plurality of triplets, and wherein the first doublet includes the training anchor element and the first candidate element and the second doublet includes the training anchor element and the second candidate element.

5. The system of claim 3, wherein the second candidate element is selected based on a negative interaction.

6. The system of claim 1, wherein the Siamese wide and deep training framework comprises a first neural network and a second neural network having identical parameters and weights, and wherein the Siamese wide and deep training framework implements a joint loss function based on an output of the first neural network and the second neural network.

7. The system of claim 6, wherein the inference recommendation model comprises the first neural network generated by the Siamese wide and deep training framework.

8. The system of claim 1, wherein the set of similar elements is generated by re-ranking an output of the inference recommendation model based on a rank score representative of a value and a relevance of each candidate element.

9. The system of claim 8, wherein the set of similar elements is generated by mapping a first set of candidate elements to a first range of ranking values based on a rank score and mapping a second set of candidate elements to a second range of ranking values based on the similarity score.

10. A computer-implemented method, comprising:
training an inference recommendation model by a Siamese wide and deep training framework comprising a first neural network and a second neural network having identical parameters and weights, and wherein the Siamese wide and deep training framework implements a joint loss function based on an output of the first neural network and the second neural network;
receiving an interface request identifying an anchor element;
generating a set of similar elements for the anchor element identifier by implementing the inference recommendation model to receive at least one recall set of candidate elements and generate a similarity score for each candidate element in the set of candidate elements and the anchor element; and
generating and transmitting an interface including at least one similar element selected from the set of similar elements to a user device associated with the interface request.

11. The computer-implemented method of claim 10, wherein the inference recommendation model comprises a pair-wise wide and deep network.

12. The computer-implemented method of claim 10, wherein the Siamese wide and deep training framework is configured to receive a training dataset including a plurality of triplets including a training anchor element, a first candidate element, and a second candidate element.

13. The computer-implemented method of claim 12, wherein the Siamese wide and deep training framework is configured to generate a first doublet and a second doublet for each triplet in the plurality of triplets, and wherein the first doublet includes the training anchor element and the first candidate element and the second doublet includes the training anchor element and the second candidate element.

14. The computer-implemented method of claim 12, wherein the second candidate element is selected based on a negative interaction.

15. The computer-implemented method of claim 10, wherein the inference recommendation model comprises the first neural network generated by the Siamese wide and deep training framework.

16. The computer-implemented method of claim 10, wherein the set of similar elements is generated by re-ranking an output of the inference recommendation model based on a rank score representative of a value and a relevance of each candidate element.

17. The computer-implemented method of claim 16, wherein the set of similar elements is generated by mapping a first set of candidate elements to a first range of ranking values based on a rank score and mapping a second set of candidate elements to a second range of ranking values based on the similarity score

18. A non-transitory computer readable medium having instructions stored thereon, wherein the instructions, when executed by at least one processor, cause at least one device to perform operations comprising:
receiving an interface request identifying an anchor element;
generating a set of similar elements for the anchor element identifier by implementing a pair-wise wide and deep network generated by a Siamese wide and deep training framework, wherein the pair-wise wide and deep network is configured to receive at least one recall set of candidate elements and generate a similarity score for each candidate element in the set of candidate elements and the anchor element; and
generating and transmitting an interface including at least one similar element selected from the set of similar elements to a user device associated with the interface request.

19. The non-transitory computer readable medium of claim 18, wherein the Siamese wide and deep training framework is configured to receive a training dataset including a plurality of triplets including a training anchor element, a first candidate element, and a second candidate element, wherein the Siamese wide and deep training framework is configured to generate a first doublet and a second doublet for each triplet in the plurality of triplets, wherein the first doublet includes the training anchor element and the first candidate element and the second doublet includes the training anchor element and the second candidate element, and wherein the second candidate element is selected based on a negative interaction.

20. The non-transitory computer readable medium of claim 18, wherein the Siamese wide and deep training framework comprises a first neural network and a second neural network having identical, parameters and weights, and wherein the Siamese wide and deep training framework implements a joint loss function based on an output of the first neural network and the second neural network, and wherein the inference recommendation model comprises the first neural network generated by the Siamese wide and deep training framework.
